(19) United States
(12) Patent Application Publication
(10) Pub. No.: US 2007/0190994 A1
(43) Pub. Date: Aug. 16, 2007

(54) Software defined radio

(75) Inventors: Yuki Sakai, Kawasaki (JP); Seiichi Nishijima, Kawasaki (JP); Naoki Oodate, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/439,981

(22) Filed: May 25, 2006

(30) Foreign Application Priority Data
Feb. 16, 2006 (JP) 2006-039564

(51) Int. Cl. H04M 3/00

(52) U.S. Cl. 455/418

(57) ABSTRACT

Reconfigurable units each include a hardware circuit having one part of a radio procedure function and a reconfigurable circuit having another part of the radio procedure function. An extension interface unit includes a switch circuit having a changeable connection specification to interconnect the reconfigurable units. A memory unit stores logic information for changing logics of the reconfigurable circuits and the connection specification of the switch circuit. A control unit downloads into the memory unit the logic information supplied from outside of the software defined radio. Rewriting the logics of the reconfigurable circuits according to the logic information and switching connection information of the switch circuit makes it possible to realize an optimum logic circuit in compliance with a radio communication to be used. In other words, it is possible to improve the scalability of the radio procedure function of the software defined radio.

### CROSS REFERENCE TO RELATED APPLICATION

This application is based upon and claims the benefit of priority from Japanese Patent Application No. 2006-039564, filed on Feb. 16, 2006, the entire contents of which are incorporated herein by reference.

### BACKGROUND OF THE INVENTION

1. Field of the Invention

The present invention relates to a software defined radio having a changeable radio communication procedure function.

2. Description of the Related Art

A software defined radio (SDR) can perform various types of radio communication by changing a radio communication procedure function by means of software. For example, the software defined radio has a reconfigurable logic circuit being able to changing a logic with software (logic information) (for example, see Japanese Unexamined Patent Application Publication No. 2000-324043).

However, in a conventional software defined radio, it is not possible to increase or decrease a reconfigurable region where a logic is rewritable. For example, when the number of gates required for a procedure function of a new radio communication is larger than that of a reconfigurable chip of an existing software defined radio, a new software defined radio needs to be designed. Also, when the number of gates necessary for the procedure function of the new radio communication is small, power needs to be supplied to the entire reconfigurable chip for the logic thereof, causing a flow of unnecessary leak current or the like due to voltage supply to an unused transistor.

### SUMMARY OF THE INVENTION

An object of the present invention is to improve scalability of a radio procedure function of a software defined radio.

Another object of the present invention is to reduce power consumption of the software defined radio by improving the scalability of the radio procedure function thereof.

In one aspect of the present invention, each reconfigurable unit includes a hardware circuit having one part of a radio procedure function and a reconfigurable circuit having another part of the radio procedure function. An extension interface unit includes a switch circuit having a changeable connection specification to interconnect the reconfigurable units. A memory unit stores logic information for changing logics of the reconfigurable circuits and the connection specification of the switch circuit. A control unit downloads into the memory unit the logic information supplied from outside of the software defined radio. Rewriting the logics of the reconfigurable circuits according to the logic information and switching connection information of the switch circuit makes it possible to realize an optimum logic circuit in compliance with a radio communication to be used. Specifically, by interconnecting the plural reconfigurable circuits via the switch circuit, it is possible to deal with a large logic scale for realizing the radio procedure function. Also, it is possible to deal with a small logic scale for realizing the radio procedure function by, for example, switching off the switch circuit to use only one reconfigurable circuit. In this case, it is not necessary to supply power to the reconfigurable circuit in which the logic is not implemented, so that the power consumption can be reduced. Thus, expansion and reduction of the reconfigurable circuits can be freely changed according to the logic scale of the radio procedure function. In other words, it is possible to improve the scalability of the radio procedure function of the software defined radio. Moreover, in general the hardware circuit can be made with a small logic scale. Accordingly, it is possible to improve the scalability of the radio procedure function of the software defined radio while keeping the circuit scale to a minimum.

In a preferred example according to one aspect of the present invention, the extension interface unit includes a radio procedure circuit having still another part of the radio procedure function. The radio procedure circuit is connectable to the reconfigurable units via the switch circuit. This accordingly enables further improvement in the scalability of the radio procedure function of the software defined radio by using the radio procedure circuit of the extension interface unit, when the logic for realizing the radio procedure function exceeds the logic scale of the reconfigurable circuits.

In a preferred example according to one aspect of the present invention, the software defined radio further includes a pair of the reconfigurable units. A first radio procedure circuit of the radio procedure circuit processes a signal outputted from one of the pair of reconfigurable units and outputs the processed signal to the other of the reconfigurable units. A second radio procedure circuit of the radio procedure circuit processes a signal outputted from the other of the reconfigurable units and outputs the processed signal to the one of the reconfigurable units. This makes processing paths for the signals be in a loop form and short. As a result, it is possible to improve the efficiency of the signal processing and the performance of the software defined radio.

In a preferred example of one aspect of the present invention, a first radio procedure circuit of the radio procedure circuit processes a signal outputted from one of the pair of reconfigurable units and outputs the processed signal to the one of the reconfigurable units. A second radio procedure circuit of the radio procedure circuit processes a signal outputted from the other of the reconfigurable units and outputs the processed signal to the other of the reconfigurable units. Accordingly, the reconfigurable units can perform a radio procedure independently, for example, simultaneous transmission/reception of plural radio waves. Also, they can simultaneously perform transmission/reception of radio waves and download of logic information.

In a preferred example of one aspect of the present invention, the radio procedure circuit is constituted of a hardware logic having a fixed logic. In general, the hardware logic can be made smaller in scale than the reconfigurable logic when the logic scale is the same. Accordingly, it is possible to decrease the layout size of the expansion interface unit, thus reducing the cost of the software defined radio.

In a preferred example of one aspect of the present invention, a card interface unit is connected to a memory card to download the logic information stored in the memory card into the control unit. An information processing interface unit is connected to an information processing apparatus to download the logic information outputted from the information processing apparatus into the control unit. A radio interface unit downloads the logic information received via an antenna into the control unit. By use of the plural interface units, it is made possible to download the logic information in the optimum conditions under various environments.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a block diagram showing a first embodiment of a software defined radio according to the present invention;

FIG. 2 is a block diagram showing details of reconfigurable chips LSI shown in FIG. 1;

FIG. 3 is a block diagram showing a main part of the software defined radio shown in FIG. 1;

FIG. 4 is a block diagram showing a layout of components constituting the software defined radio shown in FIG. 1;

FIG. 5 is an explanatory diagram showing an example of performing radio communication using the software defined radio according to the present invention;

FIG. 6 is a block diagram showing an example of using the software defined radio according to the present invention;

FIG. 7 is a block diagram showing another example of using the software defined radio according to the present invention;

FIG. 8 is a block diagram showing still another example of using the software defined radio according to the present invention;

FIG. 9 is a block diagram showing yet another example of using the software defined radio according to the present invention;

FIG. 10 is a block diagram showing yet another example of using the software defined radio according to the present invention;

FIG. 11 is an explanatory diagram showing an example of downloading logic information from a memory card into the software defined radio according to the present invention;

FIG. 12 is an explanatory diagram showing an example of downloading the logic information from a personal computer into the software defined radio according to the present invention;

FIG. 13 is an explanatory diagram showing an example of downloading the logic information using radio communication into the software defined radio according to the present invention;

FIG. 14 is a flowchart showing an example of downloading basic logic information from the memory card;

FIG. 15 is a flowchart showing an example of downloading basic logic information from FLASH;

FIG. 16 is a flowchart showing an example of downloading the basic logic information from the memory card into the FLASH;

FIG. 17 is a block diagram showing a main part of a second embodiment of a software defined radio according to the present invention; and

FIG. 18 is a block diagram showing another example of a software defined radio according to the present invention.

### DESCRIPTION OF THE PREFERRED EMBODIMENTS

Hereinafter, embodiments of the present invention will be described with reference to the drawings. In the drawings, a signal line shown by a thick line is constituted of plural lines. Part of blocks to which thick lines are connected are constituted of plural circuits. For any signal line which transmits a signal, the same reference symbol as the name of the signal is used.

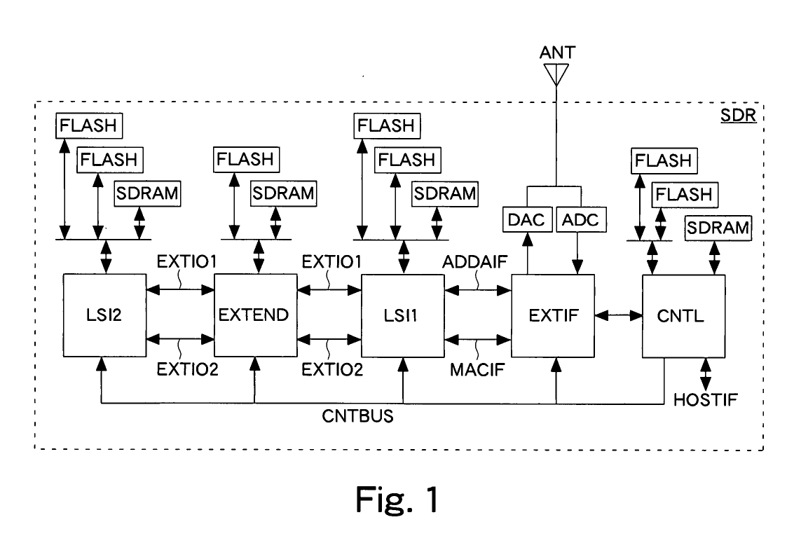

FIG. 1 shows a first embodiment of a software defined radio according to the present invention. The software defined radio SDR has a control chip CNTL (control unit), an external interface chip EXTIF, reconfigurable chips LSI1, LSI2 (reconfigurable units each having a reconfigurable logic), an extension interface chip EXTEND (extension interface unit), flash memories FLASH (memory units), SDRAMs (memory units), a DA converter DAC and an AD converter ADC.

A signal outputted from the DA converter DAC is passed through a not-shown radio procedure unit and outputted as a radio signal via an antenna ANT. A radio signal inputted to the antenna ANT is passed through the radio procedure unit and supplied to the AD converter ADC. For example, the software defined radio SDR is mounted on a mobile phone, or mounted on a radio procedure apparatus in a base station for mobile phones. By mounting the software defined radio SDR on a mobile phone, a telephone call and communication using various radio systems by a single mobile phone becomes possible. In the following, the control chip CNTL, the external interface chip EXTIF, the reconfigurable chips LSI1, LSI2, the extension interface chip EXTEND and the flash memories FLASH are also simply referred to as CNTL, EXTIF, LSI1, LSI2, EXTEND and FLASH.

The CNTL is constituted of an FPGA (Field Programmable Gate Array) in which a processor is implemented. The CNTL configures the logic of the FPGA unit by reading logic information stored in the FLASH using its implemented processor. Also, the CNTL has a function to transfer logic information supplied from the outside of the software defined radio SDR for configuring logics of the CNTL, LSI1, LSI2, EXTEND to the corresponding FLASH.

The EXTIF is constituted of an FPGA. The logic information of the EXTIF is stored for example in the FLASH connected to the CNTL. When the FPGA is constituted of a non-volatile memory, the logic information of the EXTIF may be written into the EXTIF in a manufacturing process of the software defined radio SDR. The EXTIF has an interface ADDAIF for performing processing of a radio signal which is inputted/outputted via the antenna ANT, and an interface MACIF for performing MAC (Media Access Control) processing.

Each of the LSI1, LSI2 has a processor, hardware circuits having one part of a radio procedure function, parameteral hardware circuits capable of setting parameters, and reconfigurable circuits having another part of the radio procedure function. Logics of the hardware circuits are fixed and cannot be rewritten. The parameteral hardware circuits each have, for example, a register for changing parameters such as the number of bits of data, accuracy, and the like of data to be handled during processing. Logics of the parameteral hardware circuits cannot be changed except a value that is set in the register.

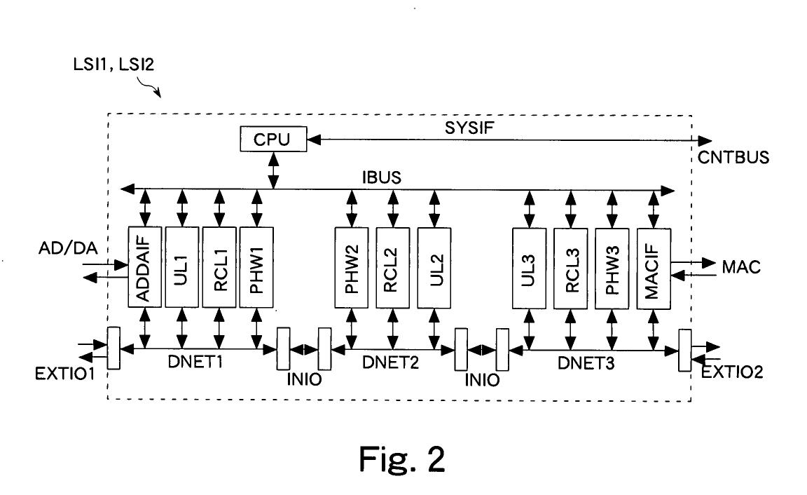

Logic information for configuring the reconfigurable circuits is stored in the FLASH connected to the respective LSI1, LSI2. Each of the LSI1, LSI2 has an interface ADDAIF for supplying/receiving a signal to/from the EXTIF, and interfaces EXTIO1, EXTIO2 for supplying/receiving a signal to/from the MACIF and EXTEND. A signal related to a radio procedure is transmitted to the interface ADDAIF. A signal related to MAC processing is transmitted to the interface MACIF. Details of the LSI1, LSI2 will be explained with FIG. 2 later.

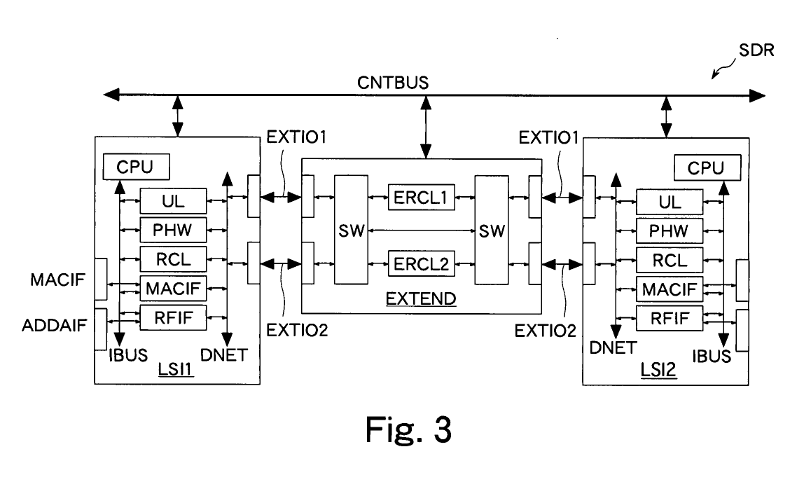

The EXTEND is constituted of an FPGA (Field Programmable Gate Array). The EXTEND has an interface for connecting the LSI1, LSI2 with each other. Logic information for configuring the EXTEND is stored in the FLASH connected to the EXTEND. Details of the EXTEND will be described with FIG. 3 later.

Note that the SDRAM functions as a buffer to temporarily store logic information or the like stored in the FLASH. For example, the logic information stored in the FLASH is being transferred to the SDRAM while the mobile phone is in an operating state. The CNTL, LSI1, LSI2, and so on read the logic information from the SDRAM upon reception of an instruction to rewrite the logic. In this manner, a time for rewriting the logic can be reduced further, compared to the case of reading the logic information from the FLASH.

FIG. 2 shows details of the LSI1, LSI2 shown in FIG. 1. The LSI1, LSI2 have the same circuit configuration, and thus only the LSI1 will be explained below. The LSI1 has a processor CPU, user logic units UL (UL1-UL3; hardware circuits), parameteral hardware units PHW (PHW1-PHW3; hardware circuits), reconfigurable units RCL (RCL1-RCL3), and the interface units ADDAIF, MACIF.

The processor CPU is connected to a higher control bus CNTBUS via a system interface SYSIF. The processor CPU controls, via an internal bus IBUS, operations of the user logic units UL, the parameteral hardware units PHW, the reconfigurable units RCL and the interface units ADDAIF, MACIF.

The user logic units UL1-UL3, the parameteral hardware units PHW1-PHW3, the reconfigurable units RCL1-RCL3 and the interface units ADDAIF, MACIF are connected with each other via data networks DNET (DNET1-DNET3). The data networks DNET are connected with each other via internal I/Os (INIO). The data network DNET1 is connected to the interface EXTIO1. The data network DNET3 is connected to the interface EXTIO2.

The user logic units UL1-UL3 are dedicated hardware each including a function that is commonly used for a predetermined radio communication system. Operations of the user logic parts UL1-UL3 are controlled depending on register values which are set by the processor CPU via the internal bus IBUS. For example, the user logic part UL1 has a tracking correction unit, a detection unit for symbol synchronous packets, a frame synchronization unit, and an error correction unit for a wide-band career frequency. The user logic unit UL2 has an error correction unit and so on for a residual career sampling frequency. The user logic unit UL3 has a preamble insertion unit and so on.

The parameteral hardware unit PHW1 has, for example, band limitation filters such as a band-pass filter and a low-pass filter. In the band limitation filters, filter coefficients, the number of taps, and so on are set as parameters. The parameteral hardware unit PHW2 has, for example, an FFT (Fast Fourier Transform) unit and a CCK modulation unit. For example, in the FFT unit, the number of points in operation is set as a parameter. The parameteral hardware unit PHW3 has a demap unit, a deinterleave unit, a depuncture unit, a viterbi operation unit, and a scramble convolutional code unit. For example, in the viterbi operation unit, a constraint length, a code rate and a checking polynomial are set as parameters.

Depending on logic information downloaded via the processor CPU, the reconfigurable unit RCL1 has a function to correct an error in wide-band career frequency and an inverse spread function, for example. Similarly, the reconfigurable unit RCL2 has a function to correct an error in narrow-band career frequency, a function of DBPSK modulation, a function of DQPSK modulation and a spread function, for example. Similarly, the reconfigurable unit RCL3 has a function of correcting an estimation of transmitting path, a puncture unit, a mapping unit, an interleave unit, a pilot insertion unit and a DQ/BPSK modulation unit and so on. The functions of the reconfigurable units RCL1-RCL3 can be changed according to downloaded logic information.

FIG. 3 shows details of the EXTEND shown in FIG. 1. The EXTEND has a pair of switch circuits SW for interconnecting the LSI1, LSI2, and reconfigurable units ERCL1, ERCL2 arranged between the switch circuits SW, and having still another part of the radio procedure function. The reconfigurable units ERCL1, ERCL2 function as a radio procedure circuit having a logic which is reconfigurable by downloading logic information. Connection information of signal lines by the switch circuits SW and logic information for configuring the logics of the reconfigurable units ERCL1, ERCL2 are stored in the FLASH connected to the EXTEND. Then, the radio procedure function configured in the LSI1, LSI2 and the radio procedure function configured in the reconfigurable units ERCL1, ERCL2 perform radio communication. Note that whether to configure the radio procedure function in the reconfigurable units ERCL1, ERCL2 or not is determined according to the scale and processing function of the radio communication system.

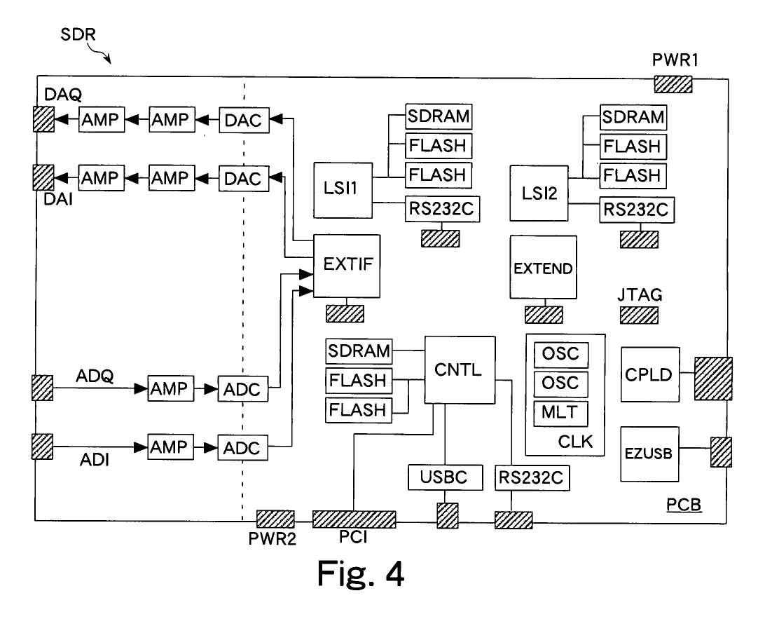

FIG. 4 shows a layout of the components constituting the software defined radio SDR shown in FIG. 1. The software defined radio SDR is constructed by mounting on a printed circuit board PCB, for example, the chips CNTL, EXTIF, LSI1, LSI2, EXTEND, FLASH, SDRAM, EZUSB, CPLD, and connectors and other electronic components. The rectangles with oblique lines show the connectors. On the left side and the right side of the dashed line in the diagram, independent power supply lines different from each other are wired respectively.

The chips EZUSB, CPLD are each constructed for example as an ASIC in which a CPU is implemented. The EZUSB controls a download operation in response to a transfer request for externally writing logic information for configuring a basic circuit of the FPGA unit of the CNTL, the logic of the FPGA unit of the EXTIF, and a basic circuit of the EXTEND. The basic circuit of the FPGA unit of the CNTL, the FPGA unit of the EXTIF, and the basic circuit of the EXTEND each configure a logic by directly receiving externally supplied logic information. Also, the EXUSB controls a download operation for the entire software defined radio SDR in response to a transfer request for externally writing logic information to the FLASH. By transferring the logic information written to the FLASH to the LSI1, LSI2, the EXTEND and the CNTL, logics of the reconfigurable units RCL of the LSI1, LSI2, the switch circuits SW of the EXTEND, the reconfigurable units ERCL1, ERCL2 and the rest of the FPGA unit of the CNTL are configured.

The CPLD has an interface for connecting a memory card via a connector. Upon reception of an instruction from the EZUSB, the CPLD reads logic information from a memory card (not shown) and outputs the read logic information to the control bus CNTBUS shown in FIG. 1.

The clock generating unit CLK has plural oscillation circuits OSC, and a multiply circuit MLT which multiplies the frequency of a clock generated by the oscillation circuits OSC. The multiply circuit MLT is used when for example, a frequency higher than the clock generated by the clock oscillation circuits OSC is required for configuration of a new radio communication function in the LSI1, LSI2 and so on.

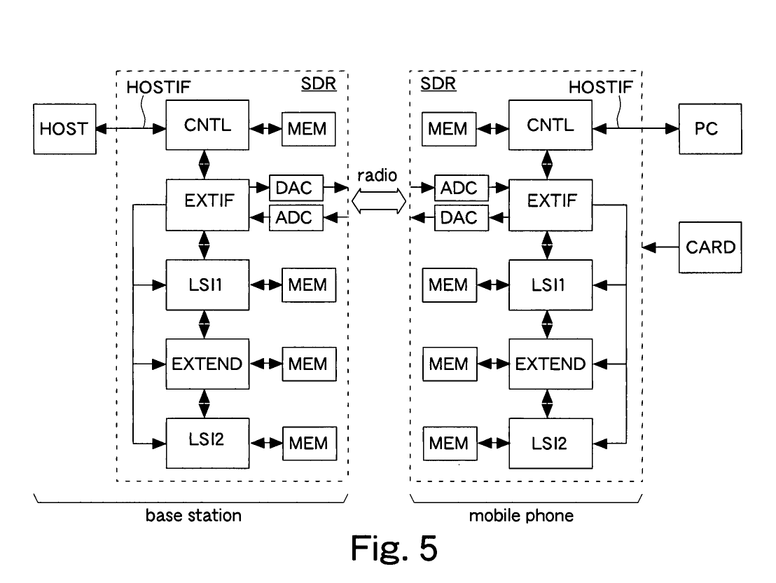

FIG. 5 shows an example of performing radio communication using the software defined radio according to the present invention. In a base station, a host interface HOSTIF of the software defined radio SDR is connected to a host computer HOST or the like. In this case, logic information of the reconfigurable logic in the software defined radio SDR is downloaded from the host computer via the host interface HOSTIF.

In a mobile phone, the host interface HOSTIF of the software defined radio SDR is connected to a personal computer. In this case, logic information of a reconfigurable logic in the software defined radio SDR is downloaded from a memory card CARD via the CPLD shown in FIG. 4. Otherwise, the logic information is downloaded from the personal computer PC via the host interface HOSTIF. Moreover, the logic information can be downloaded from the base station wirelessly. In the present invention, three interfaces are prepared for downloading the logic information, and therefore the logic information can be securely downloaded under any kind of circumstances.

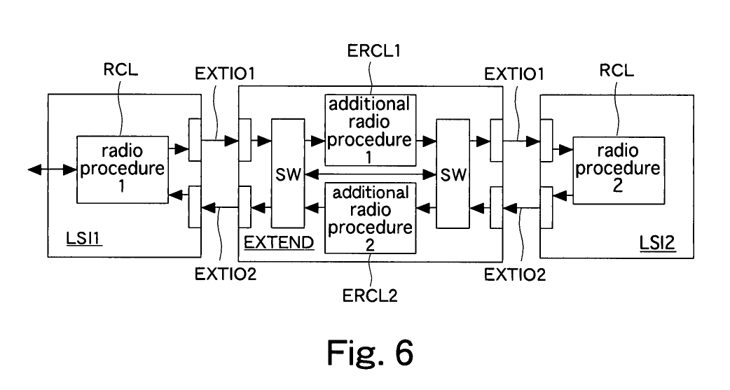

FIG. 6 shows an example of using the software defined radio SDR. In this example, the reconfigurable units ERCL1, ERCL2 of the EXTEND are used in the case where, with application of a new radio communication system, the logic is not configurable by the reconfigurable units RCL of the LSI1, LSI2 alone. The LSI1 operates as a master chip, and the reconfigurable units RCL of the LSI1 perform a radio procedure 1. The LSI2 operates as a slave chip, and the reconfigurable units RCL of the LSI2 perform a radio procedure 2.

The reconfigurable units ERCL1, ERCL2 of the EXTEND performs additional radio procedures 1, 2 respectively. In the configuration of FIG. 6, a signal is processed via a path in a loop shape in the order of the radio procedure 1, the additional radio procedure 1, the radio procedure 2, the additional radio procedure 2, and the radio procedure 1. In this manner, the processing path of a signal can be shortened, which enables improvement in efficiency of signal processing and thus improvement in performance of the software defined radio.

By arranging the EXTEND for connecting the LSI1, LSI2 with each other and forming the reconfigurable units ERCL1, ERCL2 in the EXTEND chip, the logic of the software defined radio SDR is configurable corresponding to a new radio communication system, even when adaptation of a new radio communication system was not anticipated during the development period. In other words, the use of the reconfigurable units ERCL1, ERCL2 of the EXTEND can improve the scalability of the radio procedure function of the software defined radio.

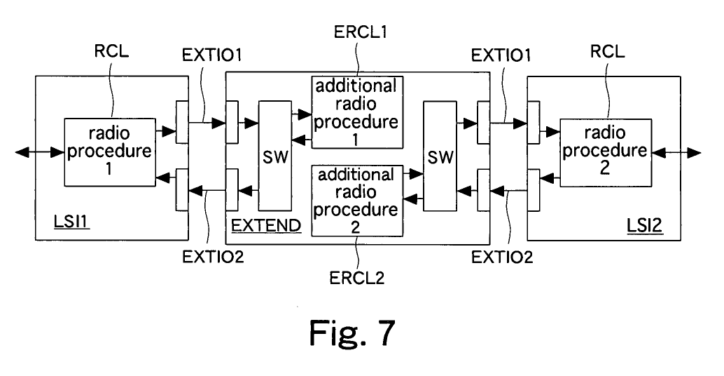

FIG. 7 shows another example of using the software defined radio SDR. In this example, the LSI1, LSI2 each perform a radio procedure independently. The LSI1 performs a radio procedure 1 and an additional radio procedure 1 together with the reconfigurable unit ERCL1. The LSI2 performs a radio procedure 2 and an additional radio procedure 2 together with the reconfigurable unit ERCL2. With this configuration, it is possible to perform communication by use of, for example, two radio communication systems without changing the logics of the reconfigurable units RCL, ERCL, and to transmit/receive plural radio waves simultaneously. In other words, different radio communication systems can be switched quickly, thereby achieving the software defined radio SDR which can be handed over seamlessly. Also, reception of television broadcast or the like during a mobile phone call is made possible. Furthermore, transmission/reception of radio waves and download of logic information can be performed simultaneously.

When the reconfigurable units RCL of the LSI1 and the ERCL1 and the reconfigurable units RCL of the LSI2 and the ERCL2 have the same radio procedure function configured, it is possible that one radio procedure function downloads logic information while the other radio procedure function is under communication. Accordingly, this eliminates the necessity of, for example, a dedicated download channel.

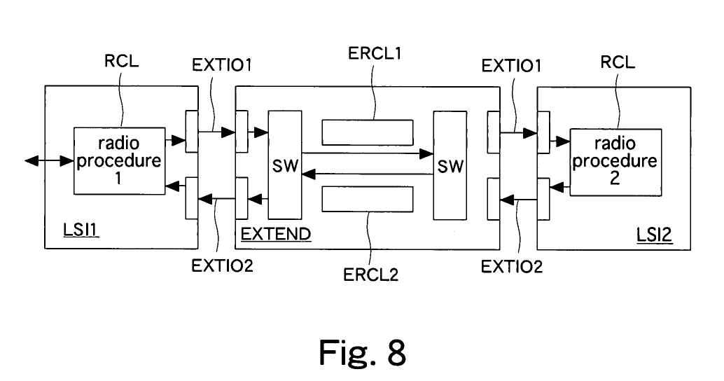

FIG. 8 is still another example of using the software defined radio SDR. In this example, the radio procedure is performed using only the LSI1, LSI2, and the reconfigurable units ERCL1, ERCL2 of the EXTEND are not used. When the radio procedure function can be realized by the reconfigurable units RCL of the LSI1, LSI2 alone, it is possible to stop the operation of the reconfigurable units ERCL1, ERCL2 of the EXTEND completely. This can accordingly reduce power consumption of the EXTEND as well as power consumption of the software defined radio SDR.

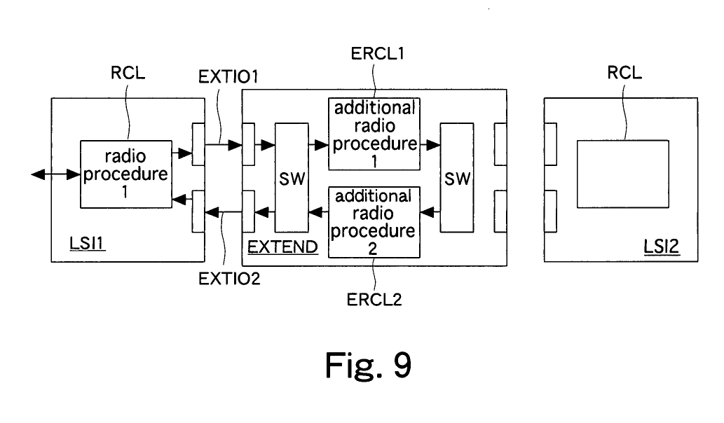

FIG. 9 shows yet another example of using the software defined radio SDR. In this example, the radio procedure is performed using only the LSI1 and the EXTEND, and the LSI2 is not used. When configurable logic with the reconfigurable units RCL of the LSI2 is smaller than that with the reconfigurable units ERCL1, ERCL2 of the EXTEND, use of the LSI1 and the EXTEND rather than the LSI1, LSI2 enables configuration of a larger logic. When a logic for realizing an additional radio procedure function is larger in scale than the reconfigurable units RCL of the LSI2, realizing the additional radio procedure function using the reconfigurable units ERCL1, ERCL2 makes it possible to stop the operation of the LSI2, thereby reducing the power consumption of the software defined radio SDR.

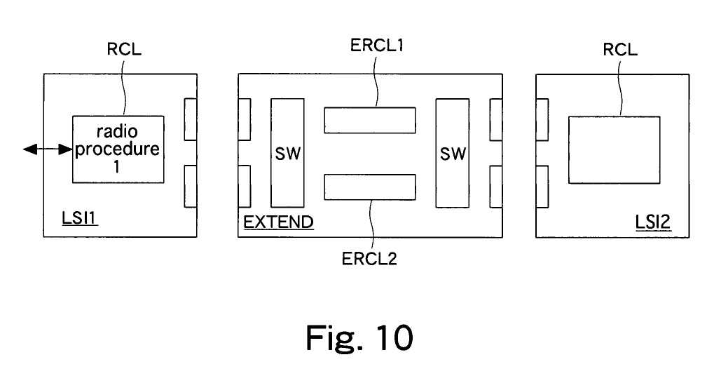

FIG. 10 shows yet another example of using the software defined radio SDR. In this example, the radio procedure is performed using only the LSI1, and the EXTEND and the LSI2 are not used. In this case, the operation of the EXTEND and the LSI2 can be stopped completely, enabling reduction of the power consumption of the software defined radio SDR. In this manner, changing the number of blocks to be operated or the number of chips to be operated according to the scale of the radio procedure function makes it possible to constantly reduce the power consumption to a minimum.

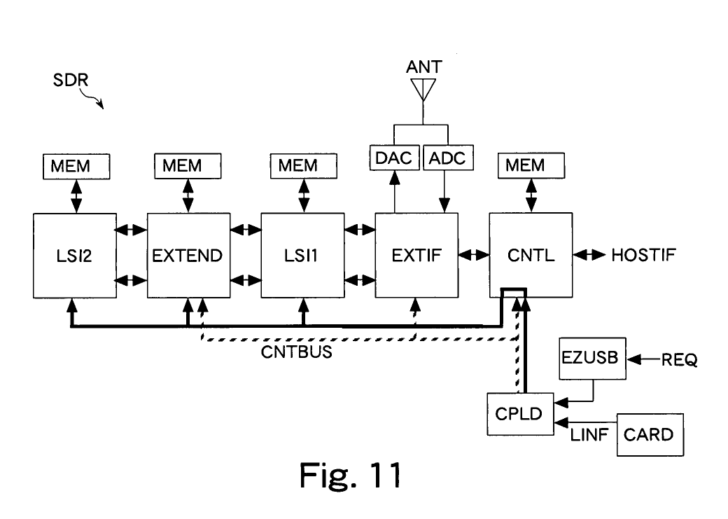

FIG. 11 shows an example of downloading logic information LINF from the memory card CARD into the software defined radio SDR. Dashed lines in the diagram show transmitting paths for basic logic information LINF for configuring the basic circuit of the FPGA unit of the CNTL, and the FPGA unit of the EXTIF and the basic circuit of the EXTEND. Thick solid lines in the diagram show transmitting paths for basic logic information LINF for realizing the radio communication function in the CNTL, the EXTEND, and the LSI1, LSI2. The basic logic information LINF is written in the corresponding FLASH via the CNTL, the EXTEND, and the LSI1, LSI2. Note that in the diagram, the FLASH and the SDRAM are shown as MEM.

Upon reception of a transfer request REQ for downloading the logic information LINF, the EZUSB responds to the transfer request REQ and instructs the CPLD (card interface unit) to start downloading. When the transfer request REQ indicates download of the basic logic information LINF, the CPLD accesses the memory card CARD to read out the basic logic information LINF and transfers it via the control bus CNTBUS to the CNTL, the EXTIF and the EXTEND.

On the other hand, when the transfer request REQ indicates download of the basic logic information LINF, the CPLD accesses the memory card CARD to read out the basic logic information LINF and transfers the read logic information LINF to the CNTL. When the transferred logic information LINF is information for realizing the function of its own FPGA unit, the CNTL writes this logic information LINF to the FLASH (MEM) connected to the CNTL. When the transferred logic information LINF is information for realizing the function of the reconfigurable units RCL of the LSI1, LSI2, the CNTL writes this logic information LINF to the FLASH (MEM) connected to the LSI1, LSI2 respectively. When the transferred logic information LINF is information for realizing the function of the reconfigurable units ERCL of the EXTEND, the CNTL writes this logic information LINF to the FLASH (MEM) connected to the EXTEND.

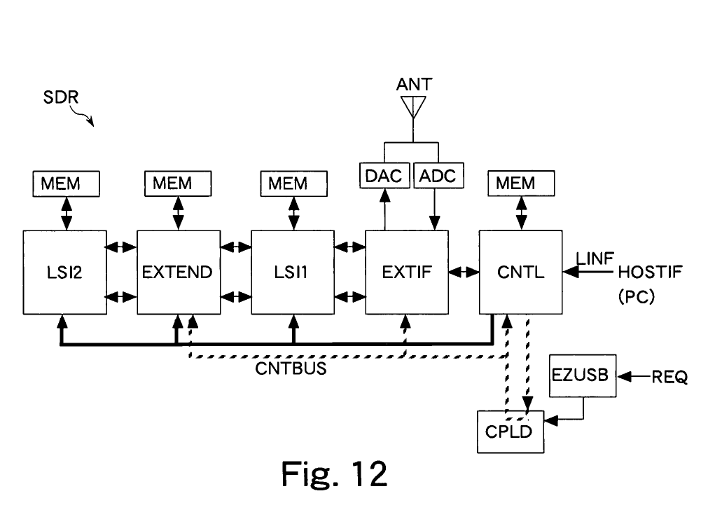

FIG. 12 shows an example of downloading the logic information LINF from a personal computer (information processing apparatus) or the like via the host interface HOSTIF into the software defined radio SDR. Meanings of dashed lines and thick solid lines in the diagram are the same as those in FIG. 11. In the diagram, the FLASH and the SDRAM are shown as MEM.

Upon reception of a transfer request REQ for downloading the logic information LINF, the EZUSB responds to the transfer request REQ and instructs the CPLD to start downloading via the host interface HOSTIF. The CPLD transmits to the CNTL the start of transfer. When the transfer request REQ indicates download of the basic logic information LINF, the CNTL (information processing interface unit) transfers to the CPLD the basic logic information LINF supplied via the host interface HOSTIF. The CPLD transfers, similarly to FIG. 11, the received logic information LINF via the control bus CNTBUS to the CNTL, the EXTIF and the EXTEND.

When the transfer request REQ indicates download of the basic logic information LINF, the CNTL writes the basic logic information LINF supplied via the host interface HOSTIF to the FLASH (MEM) connected to at least any one of the CNTL, the LSI1, LSI2 and the EXTEND.

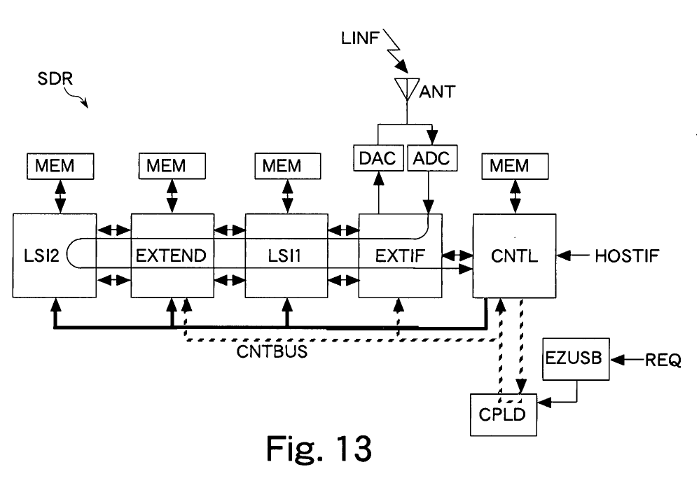

FIG. 13 shows an example of downloading the logic information LINF using radio communication into the software defined radio SDR. Meanings of dashed lines and thick solid lines in the diagram are the same as those in FIG. 11. In the diagram, the FLASH and the SDRAM are shown as MEM.

Upon reception of a transfer request REQ for downloading the logic information LINF, the EZUSB responds to the transfer request REQ and instructs the CPLD to start downloading via radio communication. The CPLD transmits to the CNTL the start of transfer. The CNTL (radio interface unit) receives the logic information LINF via the antenna ANT. At this time, the logic information LINF is transferred to the CNTL via the EXTIF, the LSI1, LSI2 and the EXTEND as shown by a horizontal U-shape arrow in the diagram. The CNTL transfers the received logic information LINF using paths of the dashed lines or paths of the thick solid lines in the diagram. Processing on the paths of the dashed lines and the paths of the thick solid lines are the same as that in FIG. 12.

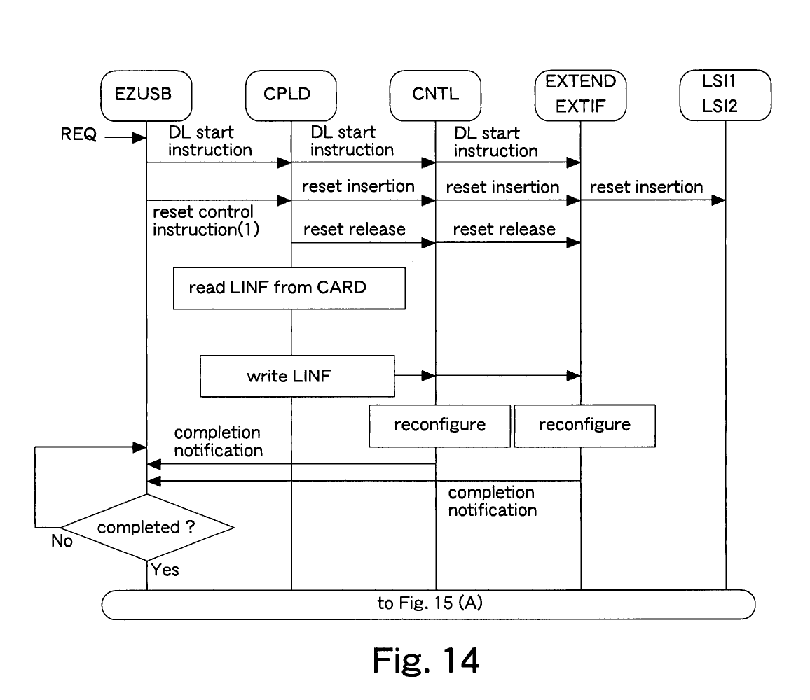

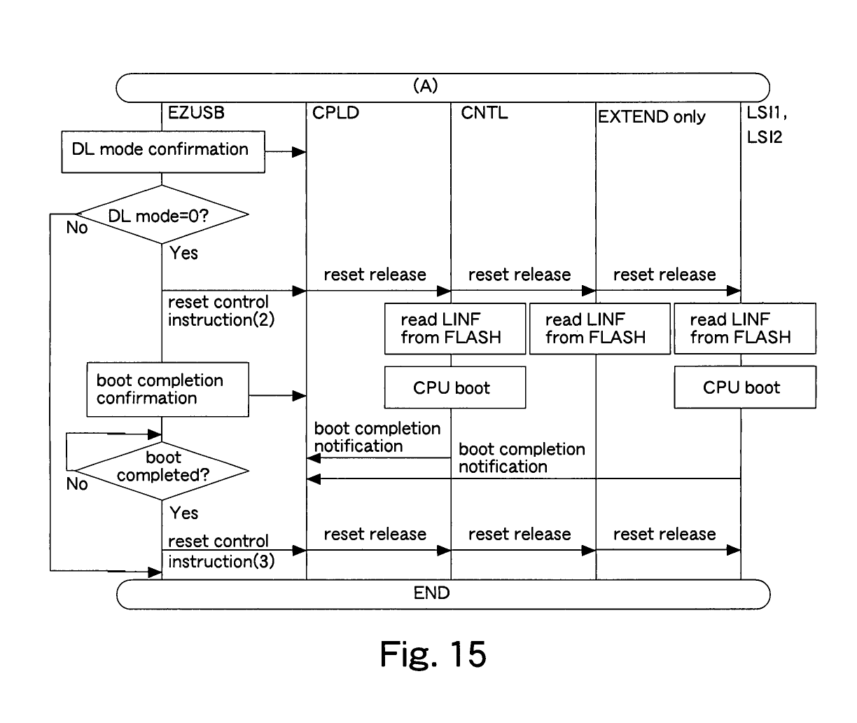

FIG. 14 and FIG. 15 show process flows of downloading the basic logic information LINF from the memory card. The EZUSB responds to a transfer request REQ and outputs a download (DL) start instruction to the CPLD. The start instruction is transmitted sequentially to the CNTL, the EXTEND, and the EXTIF. Next, the EZUSB outputs a reset control instruction (1) to the CPLD. The CPLD resets the CNTL, the EXTEND, the EXTIF and the LSI1, LSI2 sequentially. At this time, reset of the EXTEND, the EXTIF and the LSI1, LSI2 is performed by the CNTL. Next, the CPLD releases reset of the CNTL, the EXTEND and the EXTIF.

Thereafter, the CPLD reads out the basic logic information LINF from the memory card and transfers the logic information LINF to the CNTL, the EXTEND and the EXTIF. By this transfer, basic parts of logics of the CNTL, the EXTEND and the EXTIF are reconfigured. After the logics are reconfigured, the CNTL, the EXTEND and the EXTIF each output an end notification to the EZUSB via the CPLD. The EZUSB recognizes the end of reconfiguration (completion of downloading the basic logic information LINF) by receiving all the end notifications.

Next, as shown in FIG. 15, the EZUSB confirms a download (DL) mode with the CPLD.

When the download mode is “0”, the EZUSB reconfigures the logics of the CNTL, the EXTEND and the LSI1, LSI2. Specifically, the EZUSB outputs a reset control instruction (2) to the CPLD. By this instruction, reset states of the CPLD, the CNTL, the EXTEND and the LSI1, LSI2 are released. Next, the CNTL, the EXTEND and the LSI1, LSI2 read out the logic information LINF from the corresponding FLASH. In this example, logic information LINF corresponding to seven kinds of radio communication systems are written in the FLASH in advance. In other words, the software defined radio SDR is reconfigured to have the function of any one of the seven kinds of radio communication systems. When the download mode is other than “0”, the process is terminated without download.

After reading out the logic information LINF, the CNTL and the LSI1, LSI2 boot the respective processors CPU and each output a boot completion notification to the CPLD. The EZUSB confirms the boot completion with the CPLD. After confirming the boot completion, the EZUSB outputs a reset control instruction (3) to the CPLD. By this instruction, reset of the CPLD, the CNTL, the EXTEND and the LSI1, LSI2 is released. Then, the radio communication function of the software defined radio SDR is updated.

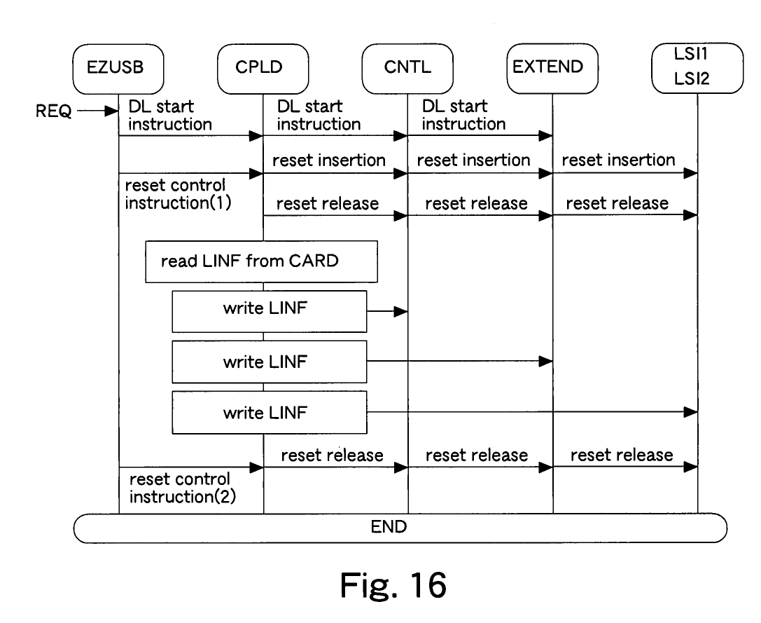

FIG. 16 shows process flows of downloading the basic logic information LINF from the memory card into the FLASH. The operation from the transfer request REQ to the first reset release is the same as that in FIG. 14. However, the basic logic information LINF is also downloaded to the FLASH of the LSI1, LSI2, and thus the reset release is also output to the LSI1, LSI2.

Thereafter, the CPLD reads out the basic logic information LINF from the memory card. The CPLD writes the read logic information LINF to the FLASH corresponding to the CNTL, the EXTEND and the LSI1, LSI2 sequentially. The processor CPU included in each chip may write the logic information LINF to the FLASH, or the CPLD may write it directly to the FLASH. Next, the EZUSB outputs the reset control instruction (2) to the CPLD. By this instruction, the CPLD, the CNTL, the EXTEND and the LSI1, LSI2 are released from the reset state. Then, writing of the basic logic information LINF to the FLASH is completed.

As above, in the first embodiment, configuring the software defined radio SDR by the LSI1, LSI2 each having the reconfigurable units RCL and the EXTEND which connects these LSI1, LSI2 with each other makes it possible to improve the scalability of the radio procedure function of the software defined radio SDR. With the formation of the fixed hardware circuits in the LSI1, LSI2, it is possible to improve the scalability of the radio procedure function of the software defined radio SDR while keeping the circuit scale to a minimum. Forming the reconfigurable units ERCL1, ERCL2 (radio procedure circuits) in the EXTEND can further improve the scalability of the radio procedure function of the software defined radio SDR. By downloading the logic information using the plural interface units, the logic information can be downloaded under the optimum conditions in various environments.

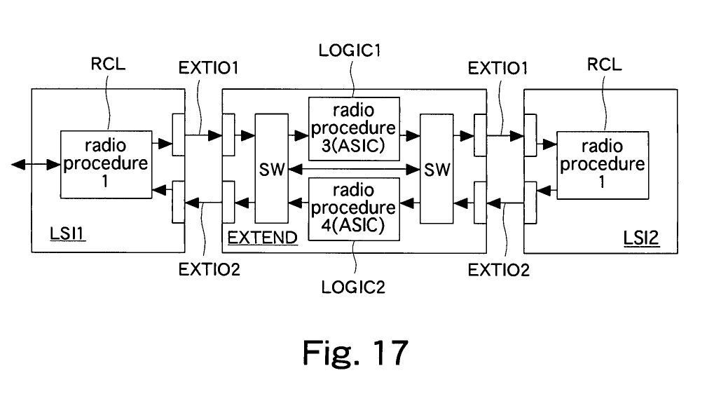

FIG. 17 shows a main part of a second embodiment of a software defined radio according to the present invention. The same elements as those explained in the first embodiment are designated the same reference symbols, and detailed explanation thereof is omitted. In this embodiment, in the EXTEND, logic units LOGIC1, LOGIC2 (hardware logics) each having a fixed logic are formed instead of the reconfigurable units ERCL1, ERCL2 in the first embodiment. The other structure is the same as the first embodiment except that the FLASH and the SDRAM connected to the EXTEND are not included. In other words, the software defined radio SDR has the structure of the above-described FIG. 1 from which the FLASH and the SDRAM connected to the EXTEND are removed.

In the logic units LOGIC1, LOGIC2, dedicated hardware for realizing a specific radio communication function is implemented. The logic units LOGIC1-2 are each formed as an ASIC such as a gate array, a cell-based IC, or the like. The dedicated hardware can be made with a smaller circuit scale as compared to a programmable circuit such as a PGA. Accordingly, the chip size of the EXTEND can be made small by forming the dedicated hardware in the EXTEND.

As above, also in the second embodiment, the same effects as those of the above-described first embodiment are obtainable. Furthermore, in this embodiment, the cost of the software defined radio SDR can be reduced by decreasing the chip size of the EXTEND.

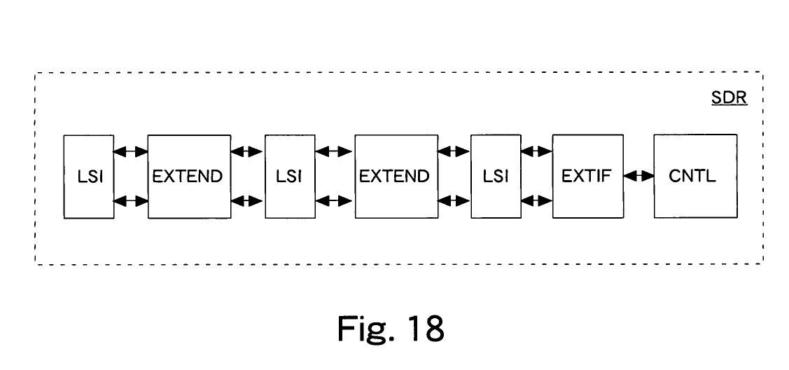

It should be noted that the above-described embodiments have described the examples of configuring the software defined radio SDR by connecting the pair of the reconfigurable chips LSI1, LSI2 by the extension interface chip EXTEND. The present invention is not limited to such embodiments. For example, as shown in FIG. 18, the extension interface chip EXTEND may be arranged between plural reconfigurable chips LSI. This accordingly can further improve the scalability of the software defined radio SDR.

The invention is not limited to the above embodiments and various modifications may be made without departing from the spirit and scope of the invention. Any improvement may be made in part or all of the components.

What is claimed is:

1. A software defined radio, comprising:
a plurality of reconfigurable units each including a hardware circuit having one part of a radio procedure function and a reconfigurable circuit having another part of the radio procedure function;
an extension interface unit including a switch circuit having a changeable connection specification to interconnect said reconfigurable units;
a memory unit which stores logic information for changing logics of said reconfigurable circuits and the connection specification of said switch circuit; and
a control unit which downloads, into said memory unit, the logic information supplied from outside of the software defined radio.

2. The software defined radio according to claim 1, wherein:
said extension interface unit further includes a radio procedure circuit having still another part of said radio procedure function; and
said radio procedure circuit is connectable to said reconfigurable units via said switch circuit.

3. The software defined radio according to claim 2, wherein
said radio procedure circuit is constituted of a reconfigurable logic.

4. The software defined radio according to claim 2, further comprising
the reconfigurable units in a pair, wherein
said radio procedure circuit comprises at least either one of:
a first radio procedure circuit which processes a signal outputted from one of the reconfigurable units and outputs the processed signal to the other of the reconfigurable units; and
a second radio procedure circuit which processes a signal outputted from the other of the reconfigurable units and outputs the processed signal to the one of the reconfigurable units.

5. The software defined radio according to claim 2, further comprising
the reconfigurable units in a pair, wherein
said radio procedure circuit includes:
a first radio procedure circuit which processes a signal outputted from one of the reconfigurable units and outputs the processed signal to the one of the reconfigurable units; and
a second radio procedure circuit which processes a signal outputted from the other of the reconfigurable units and outputs the processed signal to the other of the reconfigurable units.

6. The software defined radio according to claim 2, wherein
said radio procedure circuit is constituted of a hardware logic having a fixed logic.

7. The software defined radio according to claim 1, further comprising
a card interface unit which is connected to a memory card to download, into said control unit, the logic information stored in said memory card.

8. The software defined radio according to claim 7, further comprising
an information processing interface unit which is connected to an information processing apparatus to download the logic information outputted from the information processing apparatus into said control unit.

9. The software defined radio according to claim 8, further comprising
a radio interface unit which outputs transmission data generated by said radio procedure function to an antenna and outputs receive data received by the antenna to the radio procedure function, and has a function to download the logic information received via said antenna into said logic unit.
